(19) United States
(12) Patent Application Publication
(10) Pub. No.: US 2010/0301707 A1
(43) Pub. Date: Dec. 2, 2010

(54) APPARATUS FOR ENERGY CONVERSION, IN PARTICULAR A PIEZOELECTRIC MICROPOWER CONVERTER

(76) Inventors: Gerald Eckstein, Munchen (DE); Ingo Kühne, Munchen (DE)

Correspondence Address: STAAS & HALSEY LLP, SUITE 700, 1201 NEW YORK AVENUE, N.W., WASHINGTON, DC, 20005, US

(21) Appl. No.: 12/439,446

(22) PCT Filed: Aug. 29, 2007
(86) PCT No.: PCT/EP07/89650

§ 371 Date: Feb. 27, 2009

(30) Foreign Application Priority Data
Aug. 31, 2006 (DE) 10 2006 040 726.1

(51) Int. Cl. H02N 2/18

(52) U.S. Cl. 310/339

(57) ABSTRACT

The embodiments describe an apparatus, in particular a microsystem, including a device for energy conversion, which device has apiezoelectric, mechanically vibrating diaphragm structure for converting mechanical energy into electrical energy. The diaphragm structure being coupled to a transformer and it being possible to displace said diaphragm structure by moving the transformer, and it being possible to effect the movement of the transformer in a contact-free fashion by interaction of the transformer with a moving part.

### CROSS REFERENCE TO RELATED APPLICATIONS

This application is based on and hereby claims priority to International Application No. PCT/EP2007/058960, filed on Aug. 29, 2007, and German Application No. 10 2006 040 726.1, filed Aug. 31, 2006, the contents of both of which are hereby incorporated by reference.

### BACKGROUND

1. Field

The embodiments discussed herein relate to an apparatus, in particular a microsystem, with a device for energy conversion.

2. Background of the Invention

There is an increasing demand for microsystems in the fields of sensor systems, actuator systems, in data communications, in in-situ diagnosis and also in the area of automotive and automation technologies. Such microsystems must be supplied with energy for their operation. In such cases the microsystems should be as independent as possible, i.e. autonomous, and also maintenance-free.

Conventional self-sufficient systems are known which are operated solely by means of solar energy conversion. The disadvantage of these systems is that all application areas are excluded in which no use can be made of solar energy. Difficulties also arise in the use of solar energy by means of solar cells with miniaturization and integration into CMOS technology.

### SUMMARY

An aspect of the embodiments discussed herein is to provide energy conversion in a simple, effective and low-cost manner for an apparatus, in particular for a microsystem. The device should be able to be integrated into conventional semiconductor technologies and essentially be maintenance-free. Further requirements are wireless operation as well as an optimum miniaturization of the apparatus. The apparatus should be designed to be used especially as a sensor, an actuator and/or for data transmission and/or for in-situ diagnosis and/or as a source or generator of energy and/or as a signal generator.

It is an aspect to also make possible the in-situ diagnosis of, especially rotating, components in a simple and self-sufficient manner. An apparatus, especially a microsystem, includes a device for energy conversion, which has a piezoelectric membrane structure able to be vibrated mechanically for conversion of mechanical energy into electrical energy, with the membrane structure being coupled to a transformer and being able to be displaced by a movement of the transformer and with the movement of the transformer being able to be effected in a non-contact manner by interaction between the transformer and the moving part.

The solution to the conversion of the energy thus lies in first converting the nature of the mechanical energy, especially the movement of a component, which is adjacent to the apparatus, and then converting it into electrical energy. This means that the movement energy of the component is used to mechanically excite the membrane structure of the apparatus and to use this excitation for conversion into electrical energy. Energy is utilized by utilizing the deflection of a piezoelectric membrane structure, to which the movement of the moving component is transmitted.

The apparatus forms a generator which essentially represents a spring-mass system which is able to convert mechanical energy into electrical energy. The electrical energy is thus made available to a self-sufficient microsystem, e.g. for an in-situ diagnosis, or it can be stored. The generator obtains the mechanical energy to be converted by being coupled to the component adjacent to it and to be monitored which executes a movement during the monitoring.

The piezoelectric generator basically includes the membrane structure which contains a functional piezoelectric layer. An alternating deflection of the membrane structure leads to mechanical stress in the piezoelectric layer, so that a continuous charge displacement occurs within this layer. This charge displacement can be used for energy utilization.

In accordance with an advantageous embodiment the movement of the transformer can be effected by magnetic interaction of the transformer with the part which moves and in some places has magnetic characteristics. The transformer and thus the membrane structure are deflected by forces of attraction or repulsion, with it being possible to transmit the movement in a non-contact manner to the transformer. The advantage of this is that no or only slight constructional changes are necessary for monitoring the moving component.

In accordance with an advantageous embodiment the movement of the transformer is imparted by a rotating part, so that a periodic movement or oscillation of the transformer and the membrane structure is effected. The inventive device is thus suitable in particular for non-contact and thereby self-sufficient monitoring of rotation machines, such as shafts or turbines for example.

In accordance with an advantageous embodiment the transformer has permanent magnetic properties. These can be provided by a permanent magnet layer or a permanent magnet.

In accordance with an advantageous embodiment, for embodying the membrane structure, a piezoelectric layer arranged between two electrode layers is arranged on a wafer such that at least the electrode layer lying against the wafer extends out over a wafer cutout.

In accordance with a further advantageous embodiment, for embodying the membrane structure, the piezoelectric layer arranged between two electrode layers is arranged on a carrier layer on the wafer such that at least the carrier layer lying against the wafer extends out over the wafer cutout.

In accordance with a further advantageous embodiment, the electrode layers and the piezoelectric layer are arranged in the area of the wafer cutout. In this way the piezoelectric layer can effectively detect the vibration fluctuations.

In accordance with a further advantageous embodiment, a mass on an additional mass is mechanically coupled to the membrane structure and the transformer is provided on the additional mass. In this way the membrane structure can be made especially sensitive for mechanical energy in the form of vibrations.

The additional mass can advantageously be lying against the membrane structure and/or integrated into the carrier layer in the area of the wafer cutout and/or be integrated into one of the electrode layers in the area of the wafer cutout. In the first case, for example, lead can be applied to an electrode layer, for example by soldering it on. In the second case the carrier layer can have a boss structure. A “boss structure” is a membrane stiffened in the center.

In order to achieve a maximum deflection of the membrane structure and thereby a maximized energy yield, it is advantageous for the connection of the additional mass to the membrane structure to be made such that the stiffness is only adversely affected in a small surface section and as large a surface as possible is available for the charge transport.

In accordance with a further advantageous embodiment, the at least one membrane structure is provided as a spring-mass system with a resonant frequency such that this is situated within a frequency band of a movement of the part interacting with the transformer. The operation of the membrane structure with a resonant frequency makes possible a maximum energy yield.

In accordance with a further advantageous embodiment, the resonant frequency of the membrane structure is able to be adjusted in particular by variation of the mass and/or spring stiffness. To this end the membrane structure can have discrete mass areas which are fixed so that only the unfixed mass vibrates. Likewise a membrane structure can have areas with different spring stiffnesses, which can be explicitly selected and activated for provision of different resonant frequencies.

In accordance with a further advantageous embodiment, at least one of the electrode layers has a digital shape. Digital here merely means “subdivided”, i.e. “not contiguous”. The digital electrode surfaces are preferably designed so that they satisfy the respective equipotential surfaces as regards the mechanical stress in the layer, in order to reduce negative effects of electromechanical feedback of the piezoelectric membrane during energy conversion.

In accordance with a further advantageous embodiment, the device for energy conversion is embodied as a sensor, an actuator, for data communications and also in the area of automotive and automation technology and/or as a source of energy and/or as a signal generator and/or as a means of diagnosis.

The invention also provides a system with a moving component and an apparatus, in particular a microsystem, for energy conversion, with a mechanical movement of the transformer of the device being created in a non-contact manner by interaction with the component by the movement of the component, with the mechanical movement of the transformer able to be converted by the apparatus into electrical energy.

The apparatus used for this purpose is embodied as described above. The system has the same advantages as have already been described in connection with the inventive device.

In accordance with a further embodiment, the moving component is a rotation machine, such as a shaft, a gas turbine or a turbine blade for example. The energy necessary to excite the membrane structure can however also be obtained with a component which performs a linear movement.

In accordance with a further embodiment, a second transmission device deflecting the transformer in a non-contact manner is provided on the moving component at regular intervals.

In accordance with a further embodiment, the second transmission means is embodied by a ferromagnetic material, especially iron, cobalt or nickel, or a permanent magnet.

In accordance with a further embodiment, the second transmission means is embodied by the rotation machine itself, e.g. the blades of a turbine, provided this is made of a ferromagnetic material or is arranged thereon, e.g. the turbine blades.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a first exemplary embodiment of a piezoelectric membrane structure and a moving component coupled to this in a non-contact manner; and

FIG. 2 shows a second exemplary embodiment of a piezoelectric membrane structure and a moving component coupled to this in a non-contact manner.

In the figures the same elements are provided with the same reference symbols.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

In accordance with the exemplary embodiments a device 100 for energy conversion is used as a source of energy in the form of a piezoelectric micropower generator.

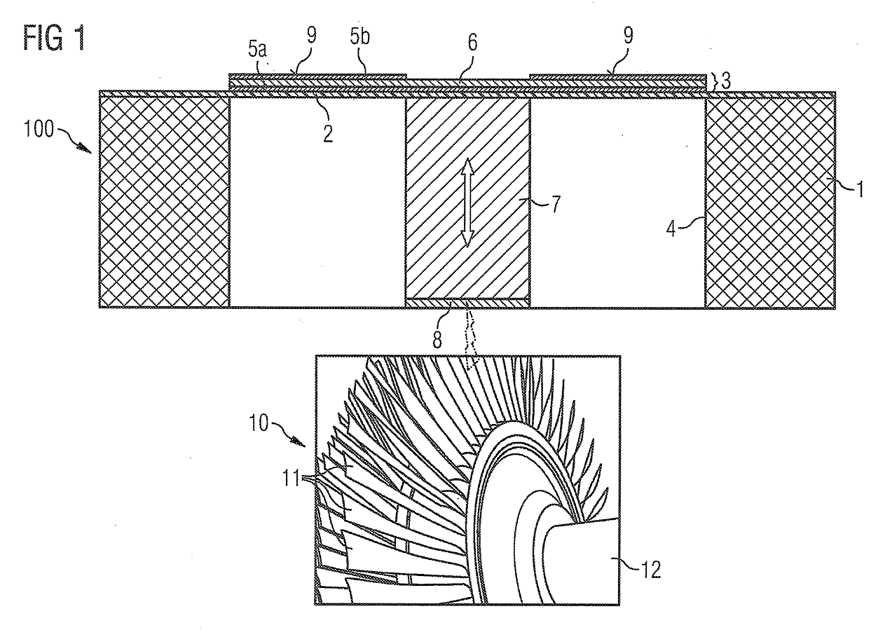

FIG. 1 shows an apparatus with a device 100 for energy conversion. The device 100 includes a wafer 1 with a wafer cutout 4 made in it. The wafer 1 can, for example, be Silicon and/or SOI (Silicon on Insulator). In the area of the wafer cutout 4 a membrane structure 3 is arranged on a carrier layer 2 on the wafer 1. The carrier layer 2 is connected to the wafer 1 so that it can vibrate.

The membrane structure 3 includes two electrode layers 5a, 5b, between which a piezoelectric layer 6 is arranged. The electrode layers 5a, 5b can be made of platinum, titanium and/or platinum/titanium or also of gold. The piezoelectric layer 6 including, for example, PZT, A1N and/or PTFE or can also be made of the material ZnO. The piezoelectric layer 6 can additionally be created as a series of layers or individually as a thin layer PVD (smaller than 5 μm) as a sol-gel layer (smaller than 20 μm), and/or as a glued-on bulk piezolayer.

The carrier layer 2 is for made from silicon, polysilicon, silicon dioxide and/or Si3N4. In this embodiment it is expedient for the carrier layer 2 to be connected with the wafer 1 to allow oscillation and in this case to extend out over the wafer cutout 4. The connection between carrier layer 2 and wafer 1 can, for example, be created by gluing or soldering.

In a further exemplary embodiment not shown, the carrier layer is created by the lower electrode layer 5a, i.e. the layer abutting the wafer 1. The lower electrode layer 5a thus simultaneously performs the function of the carrier layer 2.

Digital electrode surfaces 9, i.e. subdivided, non-contiguous electrodes of the electrode layer 5b, make it possible to reduce negative effects of electromechanical feedback of the piezoelectric membrane during energy conversion.

A mass 7 is arranged on the membrane structure 3 which extends from the electrode layer 5a out into the wafer cutout 4. The additional mass 7 is coupled to the membrane structure 3, so that movements can be detected more effectively by the membrane structure 3 and the piezoelectric layer 6.

In accordance with the exemplary embodiment of FIG. 1 a mass made of wafer material is coupled to the membrane structure 3. The additional mass 7 can be created by applying the electrode layer 5a to an upper side of the wafer 1 and by one or more subsequent etching processes through from the rear side of the wafer 1.

Alternately an additional mass 7 in the form of a sphere or another form can be coupled to the membrane structure 3. The sphere can for example be made of lead or of another material and soldered onto the electrode layer 5a. With this variant it is advantageous for the surface on which the additional mass 7 stands on the membrane structure 3 to be very small, so that only a slight stiffening of the membrane structure is produced.

Arranged on the side of the additional mass facing away from the membrane structure 3 is a transformer 8. The transformer is embodied by a permanent-magnetic layer or a permanent magnet. The transformer can for example be embodied from Nd Fe—B or Fe—Co—V. The transformer 8 interacts magnetically with a further transformer which is arranged on a rotation machine 10. The rotation machine 10 is embodied in the exemplary embodiment as a turbine rotor which has a plurality of blades 11 which are mounted on a shaft 12. The further transformer can for example be embodied by the material of the blades themselves, which are usually made of a ferromagnetic material. Frequently Fe, Co or Ni are used for this purpose. If the blades 11 are not made of a ferromagnetic material permanent magnets which assume the function of the further transformer could be arranged on their ends facing away from the shaft 12.

The device 100 for conversion of energy is for example arranged in a housing in a rotation plane of the turbine rotor which surrounds the rotating turbine rotor. In this case the transformer 8 faces towards the turbine rotor. The rotation of the turbine rotor leads to a non-contact magnetic interaction with the transformer 8, with the movement forced in the latter causing a movement of the membrane structure 3. The rotation of the turbine rotor therefore causes the membrane structure 3 to be periodically displaced, so that the resulting oscillation of the membrane structure 8 can be used for obtaining energy.

The further transformer could also be arranged on or in the area of the shaft 12 of the rotation machine 10. The further transformers made of a ferromagnetic material or in the form of permanent magnets are then arranged at intervals over the circumference of the shaft 12. This likewise leads to a mechanical stressing or oscillation of the membrane structure.

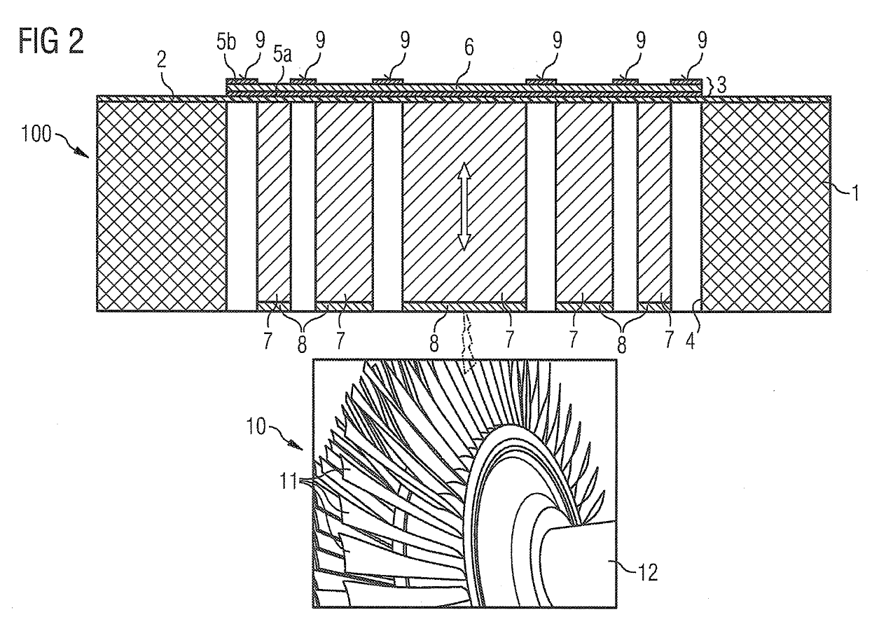

FIG. 2 shows a further exemplary embodiment of the inventive device 100, in which a number of digital masses 7, i.e. subdivided masses extend from the carrier layer 2 into the wafer cutout 4. In a corresponding manner the function layer 5b facing away from the carrier layer 2 features a number of electrode surfaces 9 which are arranged in the area of the free spaces lying between adjacent part masses. The distribution of the masses brings the advantage of a larger surface being available for generation of energy in the membrane structure 3. At the same time the stiffness can be influenced in the desired form.

By selecting the additional mass 7, the resonant frequency of the membrane structure can be adjusted in a simple, effective manner. On the other hand the resonant frequency can likewise be adjusted by defining the stiffness of the membrane structure. A further option for adjusting the resonant frequency is the selection of the corresponding materials of the membrane structure 3 for defining the spring stiffness of the membrane structure 3. Likewise the size of the wafer cutout 4 can be selected and the desired resonant frequency adapted. There are no restrictions imposed on the choice of material as regards the additional mass 7. specially dense materials make possible especially compact embodiments of a piezoelectric micropower generator for vibrations.

In accordance with the described exemplary embodiment the device for energy conversion is used as a piezoelectric micropower generator which makes it possible to supply energy from self-sufficient apparatuses or microsystems while utilizing magnetic interactions with a moving component, which are present in the surroundings of the microsystem. The piezoelectric effect in this case is not only exploited in a spatial dimension, such as for example in the arrangement of a bar, but in the entire surface of the membrane structure, so that an effective energy yield can be achieved.

The piezoelectric generator offers the advantage of a self-sufficient energy supply of a microsystem for use in rotation machines. The energy converter makes it possible to set up a diagnostic tool, which essentially does not demand any constructional change to the actual rotation machine. The microsystem makes it possible to handle the specific tasks directly at the desired location at a desired time.

The piezoelectric energy converter can be implemented in CMOS technology at wafer level and can be integrated directly into a microsystem “on-chip”.

The piezoelectric generator essentially represents a spring-mass system which is able to convert the mechanical energy of the moved parts of the rotation machine into electrical energy in a non-contact manner. The electrical energy is available to the self-sufficient microsystem or can be stored. The mechanical energy to be converted is converted in a non-contact process by means of magnetic interaction into a periodic deflection of the spring-mass system of the actual energy converter. The precondition for the creation of the movement of the membrane structure of the energy converter is the presence of a permanent magnetic layer or of a permanent magnet on the membrane structure or preferably of the additional mass connected to the membrane structure. To guarantee the magnetic interaction between the rotation machine and the actual energy converter, a ferromagnetic material or a permanent magnet is also provided on the rotation machine.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d1865 (Fed. Cir. 2004).

1-19. (canceled)

20. An apparatus, comprising:
a device for energy conversion having a piezoelectric membrane structure able to be vibrated mechanically for conversion of mechanical energy into electrical energy, and
a transformer coupled with the membrane structure with the membrane structure being able to be deflected by a movement of the transformer and with the movement of the transformer being able to be effected in a non-contact manner by interaction of the transformer with a moving part.

21. The apparatus as claimed in claim 20, wherein the movement of the transformer is able to be effected by magnetic interaction of the transformer with the part which is moving and in some sections has magnetic properties.

22. The apparatus as claimed in claim 20, wherein the movement of the transformer is brought about by a rotating part, so that a periodic movement or oscillation of the transformer and the membrane structure is effected.

23. The apparatus as claimed in claim 20, wherein the transformer has permanent magnetic properties.

24. The apparatus as claimed in claim 23, wherein the transformer is embodied by a permanent magnetic layer or a permanent magnet.

25. The apparatus as claimed in claim 20, wherein the membrane structure comprises: a wafer, two electrode layers arranged on the wafer, a piezoelectric layer arranged between the two electrode layers such that at least one of the electrode layers lying against the wafer extends out over a wafer cutout.

26. The apparatus as claimed in claim 20, wherein the membrane structure, comprises: a wafer, a carrier layer on the wafer, two electrode layers arranged on the carrier layer, a piezoelectric layer arranged between the two electrode layers arranged by the carrier layer on the wafer such that at least the carrier layer lying against the wafer extends out over the wafer cutout.

27. The apparatus as claimed in claim 25, wherein the electrode layers and the piezoelectric layer are arranged in the area of the wafer cutout.

28. The apparatus as claimed in claim 20, wherein a mass is mechanically coupled to the membrane structure and the transformer is provided on the mass.

29. The apparatus as claimed in claim 26, wherein the mass lies against the membrane structure and/or is integrated into the carrier layer and/or into one of the electrode layers in the area of the wafer cutout.

30. The apparatus as claimed in claim 20, wherein the membrane structure is provided as a spring-mass system with a resonant frequency such that, within a frequency band, subject to a movement of the part interacting with the transformer.

31. The apparatus as claimed in claim 30, wherein the resonant frequency of the membrane structure is adjusted by variation of the mass and/or spring stiffness.

32. The apparatus as claimed in claim 20, wherein at least one of the electrode layers is created digitally.

33. The apparatus as claimed in claim 20, wherein the device for energy conversion is embodied as a sensor, as an actuator for data communications and/or in the field of automotive or automation technology and/or as a source of energy and/or as a signal generator and/or as a means of diagnosis.

34. A system with a moving component and a device as recited in claim 20 whereby a mechanical movement of the transformer of the apparatus is able to be generated in a non-contact manner by interaction with the component, with the mechanical movement of the transformer able to be converted by the apparatus into electrical energy.

35. The system as claimed in claim 34, wherein the moving component is a rotation machine.

36. The system as claimed in claim 34, wherein a second transformer is provided on the moving component at regular intervals displacing the transformer in a non-contact manner.

37. The system as claimed in claim 36, wherein the second transformer is embodied by a ferromagnetic material, especially iron, cobalt or nickel, or a permanent magnet.

38. The system as claimed in claim 36, wherein the second transformer is embodied by the rotation machine itself or is arranged in the latter.
